(19) United States
(12) Patent Application Publication
(10) Pub. No.: US 2018/0364843 A1
(43) Pub. Date: Dec. 20, 2018

(54) PROJECTION DEVICE

(71) Applicant: Shenzhen Sunia Technology Company Ltd, Shenzhen (CN)

(72) Inventors: Jianming Zhuang, Shenzhen (CN); Minghui He, Shenzhen (CN); Jianbo Wang, Shenzhen (CN)

(21) Appl. No.: 15/657,151

(22) Filed: Jul. 23, 2017

(30) Foreign Application Priority Data
Jun. 15, 2017 (CN) 201720699977.6

(51) Int. Cl. G06F 3/046; G06F 3/044; H04N 9/31; G06F 3/0354

(52) U.S. Cl. CPC G06F 3/046; G06F 3/044; G06F 2203/04106; G06F 3/03545; H04N 9/3141

(57) ABSTRACT

A projection device includes a front cover, a back cover, a projection lens, a processor, and an electromagnetic touch panel for handwriting input. The electromagnetic touch panel is provided on the inside surface of the front cover and in electrical connection and communication with the processor. When the users writes directly on the front cover or on a writing sheet held by a paper holder on the front cover, the electromagnetic touch panel senses the handwriting, converts it into a writing signal and transmits the writing signal to the projection lens for the handwriting to be displayed on a screen. The projection may further include a capacitive touch panel with a silkscreen printing keypad on one side thereof for the user to key in text. The projection device effectively saves time and space in making presentations or text editing.

### BACKGROUND OF THE INVENTION

### a. Technical Field

The present invention relates to the projection technology, and in particular to a projection device having an electromagnetic touch panel for handwriting input and/or a capacitive touch panel with a silkscreen printing keypad for key input.

### b. Description of the Related Art

The projection device, also known as the projector, is a kind of device which can project image or video onto a screen. Through different interfaces the device can be connected with a computer, VCD, DVD, game console, DV, etc. to play the corresponding video signal. The projection device is widely used in homes, offices, schools and other places.

However, when doing presentations and text editing with the mobile projection device currently available in the market, the user needs to connect it to an external keyboard/handwriting tablet or mouse, which is very inconvenient.

First of all, the keyboard and the handwriting tablet are two separate devices, and the keyboard can only be input by pressing the keys whereas the writing tablet can only be input by handwriting for editing work. In addition, these two devices respond slowly. In some cases, such as when user need to quickly take note in a meeting, the conventional projection device cannot meet user's requirements. Especially for the writing tablet, it takes time for each word being input to be processed and also recognized.

Second, for those who don't know the Pinyin or Wubi input method, it is often necessary for the same projection device to be connected to both the keyboard and writing tablet, which not only take up space but also are cumbersome to carry around.

Finally, the user needs to move the mouse cursor to the right position every time before the text is to be edited. Therefore, the conventional projection device is not convenient to operate.

### SUMMARY OF THE INVENTION

In view of the above-mentioned problems, the present invention provides a projection device which effectively eliminates the inconvenience in using both the keyboard and the handwriting tablet in doing presentations and text editing.

The projection device according to the present invention includes a front cover, a projection lens, a back cover, an electromagnetic touch panel, and a processor. In such a projection device, the projection lens is provided on a lateral side of the projection device between the front cover and the back cover; the processor is placed inside the projection device; the electromagnetic touch panel is arranged on the inside of the front cover and is in electrical connection and communication with the processor.

In the present invention, the electromagnetic touch panel is integrated on the inner surface of the front cover of the projection device, so that when the user uses the projection device and requires manual input for presentation, the user can use a writing pen to write directly onto the front cover surface for input, and the processor will process the handwriting input data and project the writing to the projection screen. The combination of such handwriting input with a projection device can effectively save time and space, especially for those who are not familiar with the text input method by typing.

In another preferred embodiment of the present invention, the projection device further comprises a paper holder (such as a clip or a fine slot/groove) for holding a writing sheet (such as a piece of paper). The paper holder is provided on the front cover surface of the projection device.

With the projection device of the present invention, those who type slowly but need to quickly record the text no longer needs to worry about typing or take shorthand notes. They can simply pick up the pen to write on the front cover of the projection device or on the writing sheet placed on the front cover to realize real-time projection of the written text, and the contents of the writing will be saved on the writing sheet. In addition, during training sessions, for example, in educational institutions, one can directly write on the front cover of the projector device or on the writing sheet placed on the cover, instead of writing on a blackboard, to save time and effort.

### BRIEF DESCRIPTION OF THE DRAWINGS

The projection device of the present invention will be explained in further detail below with reference to the accompanying drawings, which are summarized below.

FIGS. 1A-1C illustrate the structure and components of the conventional projection device in the market. FIG. 1A is a front schematic view of the conventional projection device; FIG. 1B is a cross-sectional schematic view of the projection device shown in FIG. 1A; FIG. 1C is a rear schematic view of the projection device shown in FIG. 1A.

FIG. 2A and FIG. 2B illustrate the structure and components of the project device according to a first embodiment of the present invention. FIG. 2A is a front schematic view of the projection device according to the first embodiment;

FIG. 2B is a cross-sectional schematic view of the projection device shown in FIG. 2A.

FIG. 3A and FIG. 3B illustrate the structure and components of the projection device according to a second embodiment of the present invention. FIG. 3A is a front schematic view of the projection device according to the second embodiment; FIG. 3B is a cross-sectional schematic view of the projection device shown in FIG. 3A.

FIG. 4A and FIG. 4B illustrate the structure and components of the projection device according to a third embodiment of the present invention. FIG. 4A is a front schematic view of the projection device according to the third embodiment; FIG. 4B is a cross-sectional schematic view of the projection device shown in FIG. 4A.

FIG. 5A and FIG. 5B illustrate the projection device according to a fourth embodiment of the present invention. FIG. 5A is a front schematic view of the projection device according to the fourth embodiment; FIG. 5B is a cross-sectional schematic view of the projection device shown in FIG. 5A.

The reference characters used in the drawings are summarized below:

101-paper holder or clip
102-front cover
103-electromagnetic touch panel
104-writing sheet/paper
105-projection lens
106-back cover
107-processor
108-capacitive touch panel
109-silkscreen printing keypad
110-vibration motor

### DETAILED DESCRIPTION OF THE INVENTION

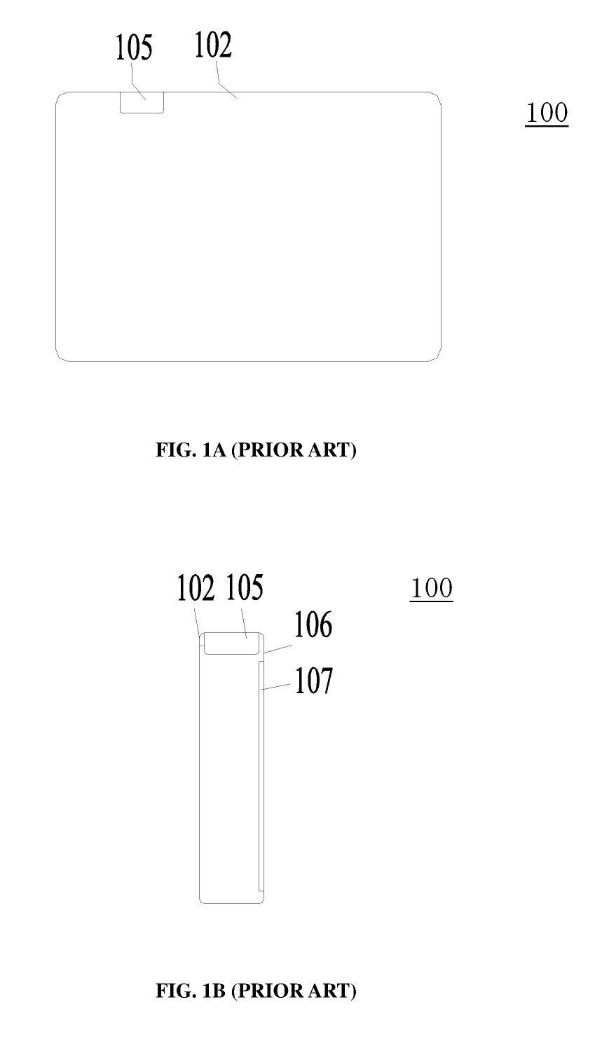

FIGS. 1A-1C illustrate the structure and components of a conventional projection device 100 in the market. Specifically, FIG. 1A is a front schematic view of the conventional projection device 100; FIG. 1B is a cross-sectional schematic view of the projection device 100; and FIG. 1C is a rear schematic view of the projection device 100. As can be seen from FIGS. 1A-1C, the conventional projection device 100 includes a front cover 102, a projection lens 105, a back cover 106, and a processor 107. In the conventional projection device 100, no additional components or designs are provided on the front cover 102 and the back cover 106.

### Embodiment I

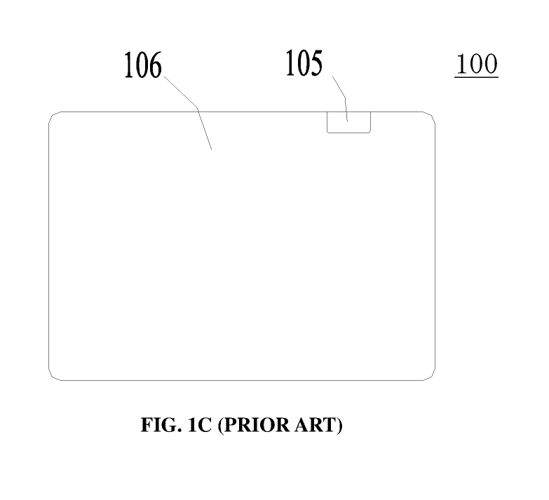

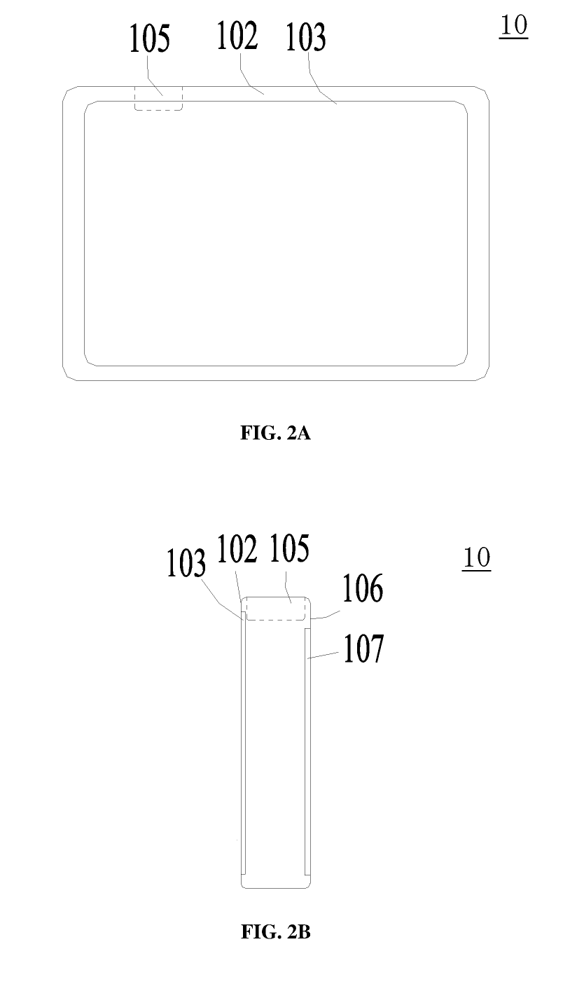

FIG. 2A and FIG. 2B illustrate the projection device 10 according a first embodiment of the present invention. Specifically, FIG. 2A is a front schematic view of the projection device 10, and FIG. 2B is a cross-sectional schematic view of the projection device 10. As illustrated, the projection device 10 includes a front cover 102, a projection lens 105, a back cover 106, an electromagnetic touch panel 103, and a processor 107. The projection lens 105 is provided on a lateral side of the projection device 10 between the front cover 102 and the back cover 106; the processor 107 is placed inside the projection device 10. The electromagnetic touch panel 103 is arranged on the inside surface of the front cover 102 and is in electrical connection and communication with the processor 107.

When a handwriting input is required during the presentation, the user writes the corresponding text directly on front cover 102 using the writing pen. Since the electromagnetic touch panel 103 is provided on the inside the front cover 102, the electromagnetic touch panel 103 senses the strokes or trajectory and pressure of the pen, and sends the writing signal to the processor 107. Then the processor 107 receives the writing signal, processes it and transmits it to the projection lens 105, which then projects the handwriting on the projection screen to display the user's written text. Thus, the combination of the handwriting with the projection device 10 effectively facilitates the user's text input, while saving time and space.

### Embodiment II

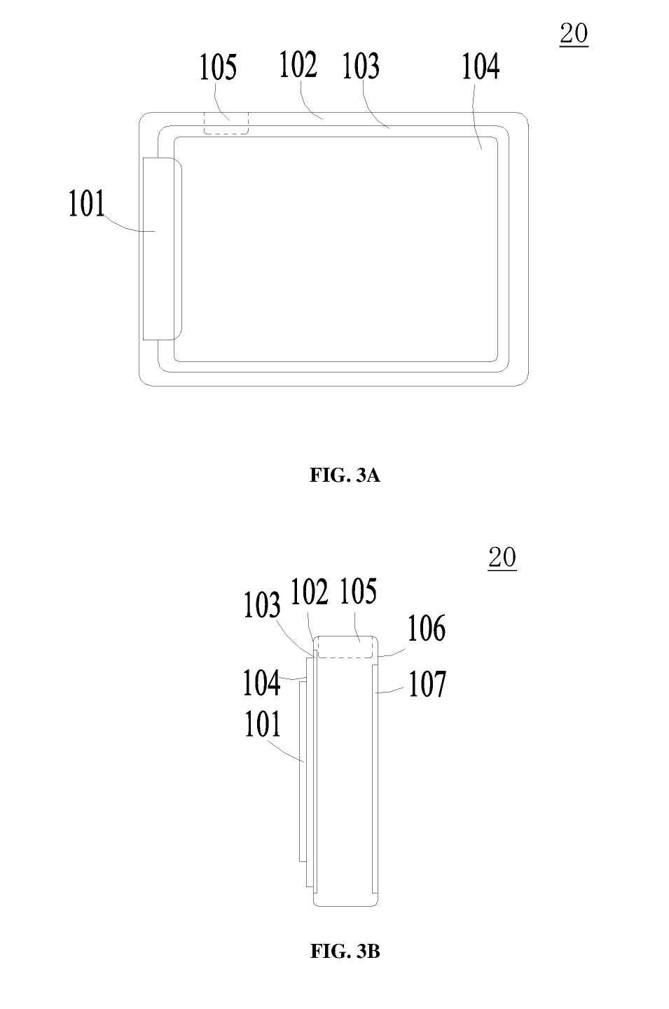

FIG. 3A and FIG. 3B illustrate the projection device 20 according to a second embodiment of the present invention, which is improved from the first embodiment described above. FIG. 3A is a front schematic view of the projection device 20, and FIG. 3B is a cross-sectional schematic view of the projection device 20. As illustrated, the projection device 20 includes a front cover 102, a projection lens 105, a back cover 106, a processor 107, and a paper holder 101 for holding a writing sheet 104. The paper holder 101 is provided on the front cover 102 of the projection device 10, and may be a clip, grip, clamp, or a fine slot adapted for holding the writing sheet. The writing sheet 104 may be a piece of paper of other thin sheets suitable for writing.

When a handwriting input is required and the writing sheet or paper 104 is required (for example, to keep a manuscript) during the presentation using the projection device 20, the writing sheet or paper 104 is held in the paper holder 101 for the user to write directly on the sheet 104 using a pen. The electromagnetic touch panel 103 receives the writing trajectory and the pressure and then converts it into a writing signal and sends the writing signal to the processor 107. The processor 107 receives the writing signal, processes it and then transmits it to the projection lens 105, which then projects it onto the screen. Thus, the original handwriting may be saved on the writing sheet or paper 104.

As mentioned above, the paper holder 101 may take various physical forms. A preferred form of the paper holder 101 is a slot provided on the front surface of the front cover 102 of the projection device 20. Similarly, when a handwriting input is required during the presentation using the projection device 20 and the writing sheet or paper 104 is required for recording, the writing sheet or paper 104 is fixed in the slot for the user to write the text directly.

### Embodiment III

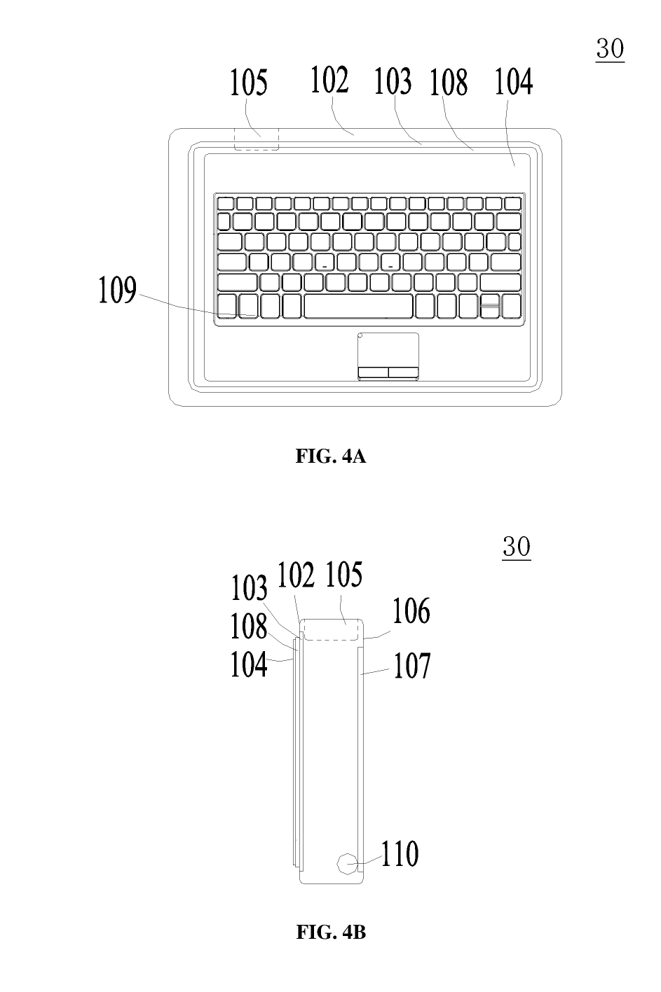

FIG. 4A and FIG. 4B show the projection device 30 according to a third embodiment of the present invention, which is improved from the first embodiment described above. Specifically, FIG. 4A is a front schematic view of the projection device 30, and FIG. 4B is a cross-sectional schematic view of the projection device 30. As shown in the FIG. 4A, the projection device 30 is different from the projection device 10 in that the projection device 30 includes a capacitive touch panel 108, a silkscreen printing keypad 109, and a vibration motor 110, in addition to the front cover 102, the electromagnetic touch panel 103, the projection lens 105, the back cover 106, and the processor 107. In the projection device 30, the capacitive touch panel 108 is provided on the outside surface of the front cover 102 and in electrical connection and communication with the processor 107. The silkscreen printing keypad 109 is provided on one side of the capacitive touch panel 108 (i.e., the silkscreen printing keypad 109 is provided on the outer surface or the inner surface of the capacitive touch panel 108). The vibration motor 110 is connected to the processor 107 and the capacitive touch panel 108, respectively.

In application, when a handwriting input is required during the presentation using the projection device 30, the user writes the corresponding text directly on the electromagnetic touch panel 103 using the pen, and the electromagnetic touch panel 103 senses the trajectory and pressure of the writing pen and sends the corresponding writing signal to the processor 107. When the processor 107 receives the writing signal, it sends a control signal to close capacitive touch panel 108, and then processes the writing signal transmitted from the electromagnetic touch panel 103 and transmits the processed signal to the projection lens 105 to project the user handwriting to the screen.

When keyboard input is required, for example, when an official document is to be edited for display or printing, the user touches the capacitive touch panel 108 by hand, the processor 107 receives the touch signal of the capacitive touch panel 108, sends a control signal to turn off the electromagnetic touch panel 103; the user can then use the silkscreen printing keypad 109 on the capacitive touch panel 108 to input characters, and the processor 107 drives the vibration motor 110 to vibrate upon each press on the silkscreen printing keypad 109. In this case, The processor 107 processes the text inputted by the user according to the key signal and transmits the data to the projection lens 105 to be projected onto the screen for display.

In the present embodiment, the processor 107 may control the operation state of the electromagnetic touch panel 103 or the capacitive touch panel 108 either by transmitting a control signal or by hardware (e.g. via the output pin level of the electromagnetic touch panel 103 and the capacitive touch panel 108). No specific restrictions are imposed in the present invention.

### Embodiment IV

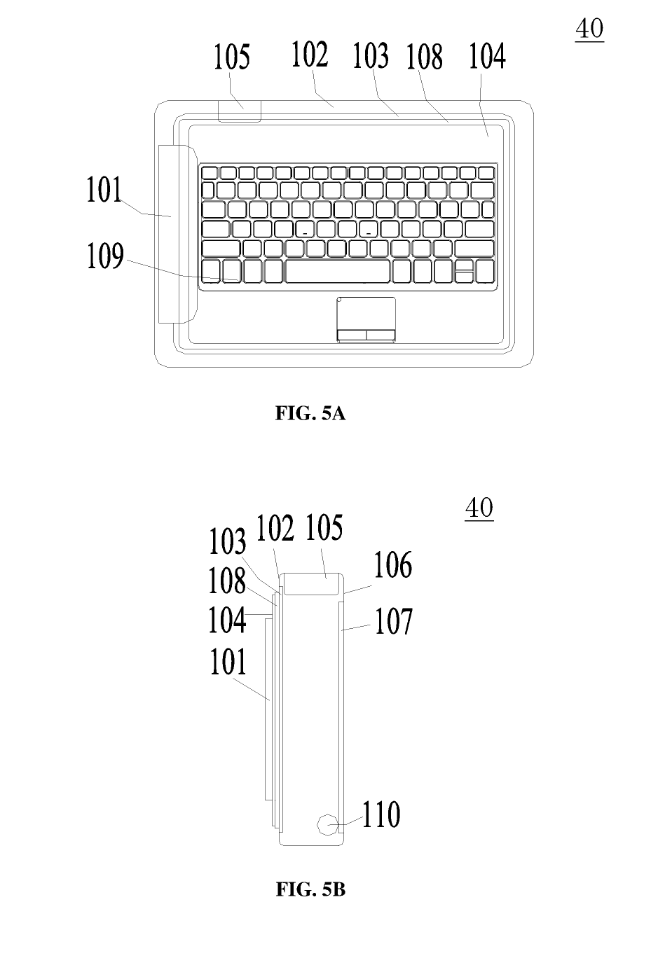

FIG. 5A and FIG. 5B illustrate the projection device 40 according to a fourth embodiment of the invention, which is improved from the fourth embodiment described above. Specifically, FIG. 5A is a front schematic view of the projection device 40, and FIG. 5B is a cross-sectional schematic view of the projection device 40. The projection device 40 is different from the projection device 30 in that in addition to the front cover 102, the projection lens 105, the back cover 106, the processor 107, the electromagnetic touch panel 103, the capacitive touch panel 108 (with a silkscreen printing keypad 109 on one side thereof) and the vibration motor 110, the projection device 40 further includes a paper holder or slot 101. The capacitive touch panel 108 is placed on the surface of the front cover 102 and in electrical connection and communication with the processor 107. Preferably, the silkscreen printing keypad 109 is provided on the outer surface of the capacitive touch panel 108.

In application, when a handwriting input is required and the writing sheet or paper 104 is required to be recorded during the presentation using the projection device, the paper 104 is held in the paper holder or slot 101 for the user to write directly on the writing sheet or paper 104 using a pen, and the electromagnetic touch panel 103 senses the trajectory and pressure of the pen, and sends the writing signal to the processor 107. When the processor 107 receives the writing signal, it sends a control signal to turn off the capacitive touch panel 108, and then process the writing signal and transmits the processed signal to the projection lens 105, so as to project the user's written text onto the screen.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A projection device, comprising: a front cover, a projection lens, a back cover, an electromagnetic touch panel, and a processor, wherein
the projection lens is provided on a lateral side of the projection device between the front cover and the back cover;
the processor is placed inside the projection device; and
the electromagnetic touch panel is arranged on an inside of the front cover and is in electrical communication with the processor.

2. The projection device according to claim 1, wherein the projection device further comprises a paper holder for holding a writing sheet, and the paper holder is provided on the front cover.

3. The projection device according to claim 2, wherein the paper holder is a fine slot or groove.

4. The projection device according to claim 1, wherein the projection device further comprises a capacitive touch panel and a silkscreen, wherein the capacitive touch panel is placed on an outer surface of the front cover and is electrically connected with the processor; and the silkscreen printing keypad is arranged on a side surface of the capacitive touch panel.

5. The projection device of claim 4, wherein the projection device further comprises a vibration motor electrically connected to the processor.

6. The projection device of claim 4, wherein the projection device further comprises a paper holder for holding a writing sheet, and the paper holder is provided on the front cover.
